(19) United States
(12) Patent Application Publication
(10) Pub. No.: US 2024/0054532 A1
(43) Pub. Date: Feb. 15, 2024

(54) INFORMATION PROCESSING DEVICE, CONTENT DISPLAY SYSTEM, AND CONTENT DISPLAY METHOD

(71) Applicant: Sharp NEC Display Solutions, Ltd., Tokyo (JP)

(72) Inventor: Ryoichi ARAKI, Tokyo (JP)

(21) Appl. No.: 18/377,153

(22) Filed: Oct. 5, 2023

Related U.S. Application Data
(63) Continuation of application No. PCT/JP2021/017906, filed on May 11, 2021.

(51) Int. Cl. G06Q 30/0251; G06F 3/14

(52) U.S. Cl. CPC G06Q 30/0269; G06F 3/1446

(57) ABSTRACT

An information processing device includes: a detection unit configured to detect a person from a captured image capturing the person; an estimation unit configured to estimate an attribute of the detected person; an extraction unit configured to, when a plurality of attributes are estimated from one person, extract one or more contents to be displayed, based on a plurality of confidence levels associated respectively with the plurality of attributes; and a processing unit configured to cause the one or more contents to be displayed in a display region.

The present application is a Continuation of PCT International Application No. PCT/JP2021/017906 filed on May 11, 2021, which is hereby incorporated by reference into the present application.

### TECHNICAL FIELD

The present disclosure relates to an information processing device, a content display system, and a content display method.

### BACKGROUND ART

In conventional targeted advertising systems, classifiers estimate attributes such as age and gender based on viewers' face images recognized from captured frames. Advertisement distribution devices specify one attribute (for example, “male in his twenties”) with the highest confidence level among the estimated attributes, and play an advertisement corresponding to the specified attribute.

A system has also been proposed which, when a plurality of viewers are detected from a captured frame, estimates attributes of the respective viewers and plays a plurality of contents according respectively to the estimated attributes (Patent Document 1).

### CITATION LIST

### Patent Document

[Patent Document 1] Japanese Patent Application Publication No. 2012-134836

### SUMMARY

### Technical Problems

In the above-described methods, there are cases where the estimated attribute differs from an actual attribute depending on facial features, imaging conditions, accuracy of the classifiers, and the like. When the estimated attribute differs from the actual attribute, a targeted advertisement that does not correspond to the viewers' attributes is displayed. As a result, effects of the targeted advertisement will not be expected.

The present disclosure provides an information processing device, a content display system, and a content display method capable of reducing an output of contents that do not correspond to viewers' attributes.

### Solution to the Problems

An information processing device according to one aspect of the present disclosure includes: a detection unit configured to detect a person from a captured image capturing the person; an estimation unit configured to estimate an attribute of the detected person; an extraction unit configured to, when a plurality of attributes are estimated from one person, extract one or more contents to be displayed, based on a plurality of confidence levels associated respectively with the plurality of attributes; and a processing unit configured to cause the one or more contents to be displayed in a display region.

An information processing device according to one aspect of the present disclosure includes: a detection unit configured to detect a person from a captured image capturing the person; an estimation unit configured to estimate an attribute according to the detected person; an extraction unit configured to, when a plurality of attributes are estimated from one person, extract one or more contents, a quantity of which is determined based on a plurality of confidence levels associated respectively with the plurality of attributes obtained from the one person; and a processing unit configured to cause the one or more contents to be displayed in a display region.

Further, a content display system according to one aspect of the present disclosure includes: a detection unit configured to detect a person from a captured image capturing the person; an estimation unit configured to estimate an attribute of the detected person; an extraction unit configured to, when a plurality of attributes are estimated from one person, extract one or more contents to be displayed, based on a plurality of confidence levels associated respectively with the plurality of attributes; a processing unit configured to output a playback instruction causing the one or more contents to be displayed in a display region; and a playback unit configured to play the one or more contents according to the playback instruction and cause the one or more contents to be displayed in the display region.

Further, a content display method according to one aspect of the present disclosure includes: detecting a person from a captured image capturing the person; estimating an attribute of the detected person; when a plurality of attributes are estimated from one person, extracting one or more contents to be displayed, based on a plurality of confidence levels associated respectively with the plurality of attributes; and causing the one or more contents to be displayed in a display region.

Further, a content display method according to one aspect of the present disclosure includes: detecting a person from a captured image capturing the person; estimating an attribute according to the detected person; when a plurality of attributes are estimated from one person, extracting one or more contents, a quantity of which is determined based on a plurality of confidence levels associated respectively with the plurality of attributes obtained from the one person; and causing the one or more contents to be displayed in a display region.

### Advantageous Effects

According to the present disclosure, it is possible to reduce an output of contents that do not correspond to viewers' attributes.

### BRIEF DESCRIPTION OF THE DRAWINGS

FIG. 1 is a system configuration diagram illustrating a schematic configuration of a display system 1.

FIG. 2 is a conceptual diagram illustrating a relationship between a display device 10 and a shooting range.

FIG. 3 is a functional block diagram illustrating schematic functions of an information processing device 40.

FIG. 4 is a diagram showing an example of a result of estimation by an estimation unit 405.

FIG. 5 is a flowchart illustrating an operation of an imaging device 30.

FIG. 6 is a flowchart illustrating an operation of the information processing device 40.

FIG. 7 is a flowchart illustrating an operation of a video signal output device 20.

FIG. 8 is a flowchart illustrating an operation of the display device 10.

FIG. 9 is a diagram showing a case where contents are displayed on a multi-display system.

FIG. 10 is a conceptual diagram illustrating a case where a plurality of contents are played in chronological order.

FIG. 11 is a diagram showing a configuration of an information processing device 40A which is another embodiment of the information processing device 40.

FIG. 12 is a diagram showing a configuration of an information processing device 40B which is another embodiment of the information processing device 40.

### DESCRIPTION OF EMBODIMENTS

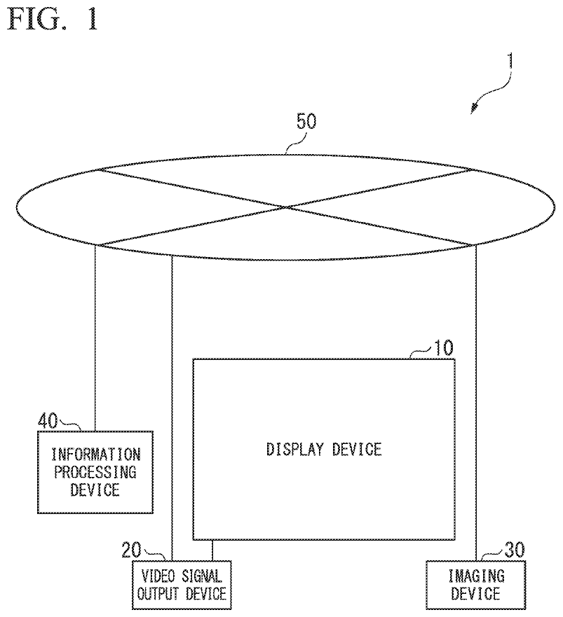

FIG. 1 is a system configuration diagram illustrating a schematic configuration of a display system 1.

The display system 1 includes a display device 10, a video signal output device 20, an imaging device 30, an information processing device 40, and a network 50.

The video signal output device 20, the imaging device 30, and the information processing device 40 are communicatively connected via the network 50. The display device 10 is electrically connected to the video signal output device 20 via a video cable.

The imaging device 30 has a function of continuously capturing a video at an arbitrary frame rate and a function of transmitting the captured image, which is a result of the capturing, to the information processing device 40 via the network 50. The imaging device 30 may be, for example, a network camera with an image sensor.

The information processing device 40 is, for example, a computer, and realizes various functions by a CPU (Central Processing Unit) reading and executing programs stored in a storage device.

The video signal output device 20 has functions of: a storage unit configured to receive and store default contents or targeted contents from the information processing device 40; a reception unit configured to receive from the information processing device 40, a playback instruction to play a default content or a targeted content; a content extraction unit configured to extract a content to be outputted, from among the default contents and the targeted contents stored in the storage unit, based on the playback instruction received from the information processing device 40; an output means configured to, when the playback instruction indicates a playback of a plurality of contents, divide a display region and output the plurality of contents together; and a video output unit configured to output a video to the display device 10 connected via the video cable. Further, the output means of the video signal output device 20 may be configured to, when the playback instruction indicates a playback of the plurality of contents, output the plurality of contents to a single display region in chronological order.

The video signal output device 20 may be any of, for example, a signage player, a computer, a video playback device, and the like.

The display device 10 displays in a display region, a video signal supplied from the video signal output device 20. For example, the display device 10 may be a liquid crystal display device or a projector. When the display device 10 is a liquid crystal display device, a video signal is displayed in a display region of a liquid crystal panel. When the display device 10 is a projector, the display device 10 projects a video signal in a display region of a screen, thereby displaying the video signal in the display region.

Further, the display device 10 may be a single display device or a plurality of display devices. When the display device 10 is a plurality of liquid crystal display devices, it is possible to construct a multi-display system in which the plurality of liquid crystal display devices are installed adjacently. Further, when the display device 10 is a plurality of projectors, it is possible to construct a multi-display system by projecting video signals so that the video signals projected from the plurality of projectors are adjacent to each other.

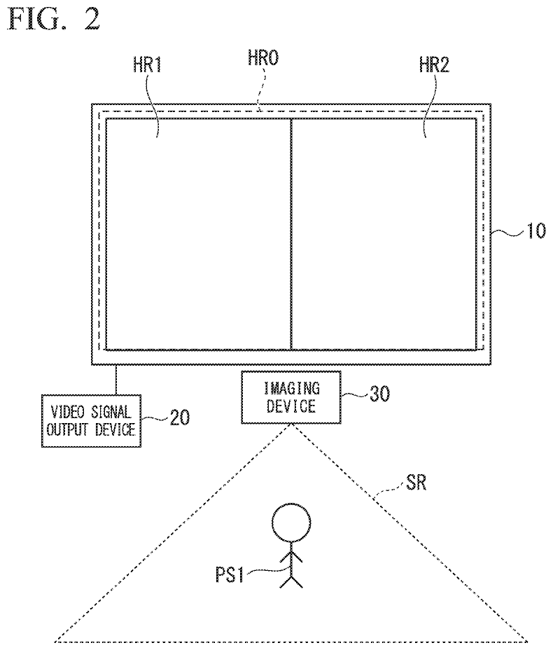

FIG. 2 is a conceptual diagram illustrating a relationship between the display device 10 and a shooting range.

Here, a case where the display device to be installed is a single display device 10 will be described. Also, a case where a single display region of a display screen of the display device 10 is divided into a plurality of display regions will be described.

Here, a single display region HR0 of the display device 10 is divided into a divided region HR1 and a divided region HR2. The divided region HR1 and the divided region HR2 are arranged in a horizontal direction. Here, a case where a quantity of divisions is 2 will be described, but the quantity of divisions may be any number of 3 or more. Further, the divided regions may be arranged in the horizontal direction or a vertical direction. Moreover, a division may be made so that the divided regions are arranged in a plurality of columns in the vertical direction and a plurality of rows in the horizontal direction.

Further, all of the divided regions may have the same size, or some of the divided regions may have different sizes from the other divided regions. Moreover, the divided regions may have the same shape or different shapes.

In the present embodiment, although the case of dividing the single display region into the plurality of regions to obtain the plurality of divided regions will be described, there may be a case of using a plurality of display regions, other than the case of diving the single display region. For example, in a multi-display system in which m display devices are arranged (where m is a natural number of 2 or more), one display region may be displayed by n display devices (where 1≤n<m), and the other display regions may be displayed by the remaining display devices.

Even if it is not the case of the multi-display system, when another display device is installed near the display device 10, a content can be displayed by setting the display region of the display device 10 as one divided region, and a display region of the other display device as another divided region.

Such a display device 10 is installed in places where a plurality of people can visit, such as station premises, squares in front of stations, public facilities, and event venues. The display device 10 is used as a public display when installed in a public place.

The display device 10 can also output audio. In this case, the display device 10 may output either one or both of the sounds of the contents displayed in the respective divided regions.

The imaging device 30 is provided near the display device 10. Here, a case will be described in which the imaging device 30 captures an image of a shooting range SR, which is a region where a content displayed on the display device 10 can be viewed. The shooting range SR is a region where users can pass through and may also stop.

This figure shows a case where a user PS1 who is a viewer is present in the shooting range SR at a certain moment.

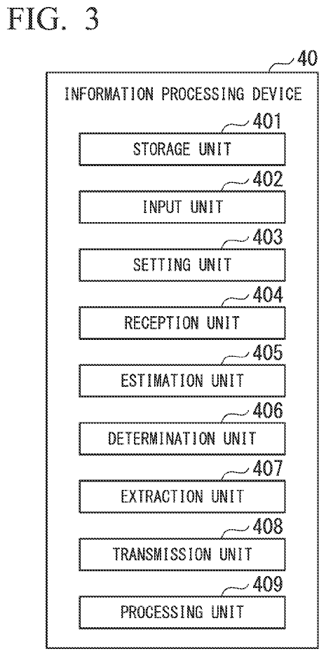

FIG. 3 is a functional block diagram illustrating schematic functions of the information processing device 40.

A storage unit 401 stores various data.

For example, the storage unit 401 stores various contents. Contents are not limited as long as they include images visually recognizable by users, and may be still images or moving images. Further, contents may include not only images, but also sounds. Users can view (visually recognize) images when contents include only images, and can view images with sounds w % ben contents include images and sounds.

Contents may be any of advertisements, notices, guidance, or the like. A content has a predetermined playback time. A playback time is a time from a start of a playback to an end of the playback. Examples of contents include a content with a playback time of 15 seconds and a content with a playback time of 30 seconds. Further, when a content is a still image, a playback thereof may be terminated in the middle after the playback is started, even before a playback end time comes, if there is a targeted content to be displayed preferentially.

Further, a playback time of a default content may be set shorter than a playback time of a targeted content. Since default contents end faster than targeted contents, end timings of default contents come faster, so that the chances of displaying targeted contents can be increased.

In the present embodiment, a case where contents are advertisements will be described as an example.

Contents include targeted contents and default contents.

A targeted content is a content according to an attribute of a person included in an image captured by the imaging device 30. A targeted content is associated with attribute data indicating an attribute of a target and stored in the storage unit 401.

A default content is a content that is not related to a specific person. A default content may be a content other than a targeted content. As a default content, for example, at least one content to be outputted according to the date and a time zone is selected.

An input unit 402 receives an operation input from an input device such as a mouse or a keyboard.

A setting unit 403 performs a process of setting data necessary in the display system 1. The setting unit 403 receives via the input unit 402, an operation input by an operator from the input device, and sets a targeted content and a default content according to the operation input.

A reception unit 404 receives a captured image transmitted from the imaging device 30. The reception unit 404 continuously receives image data (captured images) sequentially generated at the frame rate from the images captured by the imaging device 30. The captured image received by the reception unit 404 is a captured image capturing a visible region (i.e., shooting range SR).

An estimation unit 405 performs image recognition processing to detect a person from the captured image received by the reception unit 404 from the imaging device 30, and estimates an attribute of the person based on a result of the detection. When a single person is detected from the captured image, the estimation unit 405 estimates an attribute of that single person. When a plurality of persons are detected from the captured image, the estimation unit 405 can also estimate attributes of the respective persons.

Examples of attributes include age, gender, occupation, clothing, and the like. The estimation unit 405 may estimate one or more attributes among a plurality of attributes such as age, gender, occupation, and clothing. An attribute to be estimated is not limited, and may be arbitrary.

The estimation unit 405 estimates an attribute of the person and obtains a confidence level. A confidence level represents a probability that the estimated attribute is correct. A confidence level may also be referred to as “certainty” or “confidence.”

There are cases where confidence levels differ depending on a state in which an image of a person is captured by the imaging device 30. For example, estimated values of confidence levels vary depending on such a case as where the face of a person is oriented horizontally or vertically with respect to the imaging device 30, where a person is wearing a mask that covers the nose and mouth, where a person is pulling a hat down, or where a distance from the imaging device 30 to a person is long.

For example, the estimation unit 405 may input the captured image obtained from the imaging device 30 to a trained model that has undergone pre-learning, such as deep learning or the like, using a large number of images including people of various ages and genders, thereby performing the process of detecting a person and the process of estimating an attribute. A classifier that estimates an attribute from a person can be used for the estimation unit 405.

A determination unit 406 determines a magnitude relationship between a reference value and a confidence level associated with each attribute. The reference value may be predetermined and stored in the storage unit 401.

An extraction unit 407 extracts a targeted content based on the attribute estimated by the estimation unit 405. The extraction unit 407 determines a quantity of contents based on the confidence level associated with the attribute obtained from the estimation unit 405. For example, when a single attribute is estimated and a single confidence level associated with that single attribute is obtained, the quantity of confidence levels is one, so that the extraction unit 407 determines a quantity of contents to be one.

When a plurality of attributes are estimated, the extraction unit 407 extracts a plurality of contents corresponding respectively to the plurality of attributes. When extracting a plurality of contents, the extraction unit 407 determines a quantity of contents to be extracted. When determining a quantity of contents, if a plurality of attributes are estimated from a single person, the extraction unit 407 can determine a quantity of contents to be extracted, based on a plurality of confidence levels associated respectively with the plurality of attributes obtained from that single person.

When determining a quantity of contents based on confidence levels, a quantity of contents may be determined by determining the confidence levels using a reference value. In this case, when the highest confidence level is less than the reference value based on a result of the determination by the determination unit 406, the extraction unit 407 extracts a plurality of contents to be displayed, based on the plurality of confidence levels associated respectively to the plurality of attributes obtained from the single person. When the highest confidence level is less than the reference value, a quantity of contents is determined to be 2, and contents corresponding respectively to the attributes associated respectively with the two highest confidence levels are extracted.

In the case where the magnitude relationship between each confidence level and the reference value is determined, and a quantity of contents is determined according to a result of the determination, it can be determined that the estimated attribute is highly likely to differ from the viewer's actual attribute, and it is possible to display a targeted content corresponding to the attribute associated with the highest confidence level and a targeted content corresponding to at least one of the attributes associated respectively with the second, third, . . . , and n-th highest confidence levels.

Further, when determining a quantity of contents based on confidence levels, a quantity of contents may be determined according to a quantity of attributes associated with highest confidence levels which are close to each other (for example, when a difference in confidence level is within a predetermined value). For example, when a difference between highest confidence levels associated respectively with a plurality of attributes is within a predetermined value, a plurality of contents to be displayed may be extracted. More specifically, when the two highest confidence levels are close to each other, a quantity of contents is determined to be 2, and when the three highest confidence levels are close to one another, a quantity of contents is determined to be 3. For example, when the highest confidence level is 50%, the second highest confidence level is 40%, and the third highest confidence level is 5%, a quantity of contents is determined to be 2. Also, for example, when the highest confidence level is 40%, the second highest confidence level is 30%, the third highest confidence level is 25%, and the fourth highest confidence level is 5%, a quantity of contents is determined to be 3.

Whether the confidence levels are close to each other may be determined by the determination unit 406. In this case, the determination unit 406 previously stores a reference value for a difference in confidence level, and may determine that highest confidence levels are close to each other when a difference therebetween is within the reference value.

When several highest confidence levels associated respectively with the obtained attributes are close to some extent, it is difficult to determine which of the estimated attributes corresponds to the person's actual attribute. When the extraction unit 407 refers to the obtained difference in confidence level and determines that the difference in confidence level is within a predetermined value (i.e., the confidence levels are close to some extent), the extraction unit 407 may, according to a result of the determination, determine a quantity of contents to be displayed, based on a quantity of confidence levels whose difference is within the predetermined value.

Thus, the extraction unit 407 determines a quantity of contents based on the confidence levels associated respectively with the attributes obtained from a single viewer, so that when a plurality of attributes are estimated for a given viewer, not only a content corresponding to a first candidate, but also a content corresponding to a second candidate (or third candidate) can be selected and displayed.

A transmission unit 408 transmits various data.

For example, the transmission unit 408 reads the default contents or targeted contents stored in the storage unit 401 and distributes the read default contents or targeted contents to the video signal output device 20 connected via the network 50.

A processing unit 409 causes the transmission unit 408 to transmit to the video signal output device 20, a playback instruction to play a content. A playback instruction includes a playback instruction to play a default content and a playback instruction to play a targeted content.

When the extraction unit 407 extracts a plurality of contents, the processing unit 409 causes the transmission unit 408 to transmit to the video signal output device 20, a playback instruction to play the extracted plurality of contents. When a plurality of contents are to be played, the processing unit 409 can cause the transmission unit 408 to transmit to the video signal output device 20, a playback instruction to arrange and display the plurality of contents respectively in different display regions. Further, when a plurality of contents are to be played, the processing unit 409 can cause the transmission unit 408 to transmit to the video signal output device 20, a playback instruction to display the plurality of contents in chronological order.

When a plurality of contents are to be displayed in a single display region, the processing unit 409 can also cause the plurality of contents to be arranged and displayed respectively in a plurality of regions divided from the single display region. In this case, the plurality of contents can be displayed together on the single display device 10.

When a plurality of contents are to be displayed in a single display region, the processing unit 409 can also cause the plurality of contents to be displayed in a display region of a multi-display system. In this case, the plurality of contents can also be arranged and displayed respectively in a plurality of regions divided from a single display region including a plurality of display screens of the multi-display system.

Further, when a plurality of contents are to be played, the processing unit 409 can also cause the transmission unit 408 to transmit to the video signal output device 20, a playback instruction to display the plurality of contents in a single display region in chronological order. In this case, even if only one display region is used, the plurality of contents can be displayed sequentially.

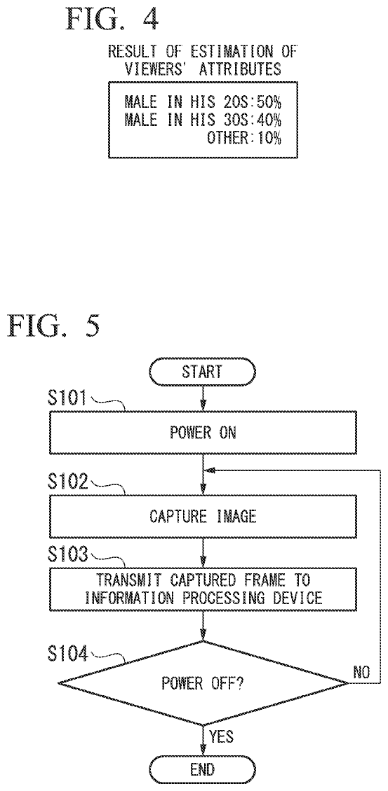

FIG. 4 is a diagram showing an example of a result of estimation by the estimation unit 405.

The result of estimation by the estimation unit 405 includes estimated attributes and confidence levels. Further, there are cases where a result of estimation is obtained as plural combinations of attributes and confidence levels. For example, there is a case where a result of estimation is obtained as plural combinations such as a combination of an attribute “male in his 20s” and a confidence level “50%,” a combination of an attribute “male in his 30s” and a confidence level “40%,” and a combination of an attribute “other” and a confidence level “10%.”

Here, although the case where the attributes include age and gender is illustrated, a single attribute or another combination of attributes may be obtained.

Next, an operation of the display system 1 with the above-described configuration will be described.

### [Preparation]

Each of the display device 10, the video signal output device 20, the imaging device 30, and the information processing device 40 is powered on. The video signal output device 20, the imaging device 30, and the information processing device 40 are communicatively connected via the same network 50. The video signal output device 20 is connected to the display device 10 via a video cable. The imaging device 30 continuously transmits to the information processing device 40 via the network 50, captured images obtained by imaging the shooting range SR at an arbitrary frame rate.

The information processing device 40 specifies a plurality of default contents to be default advertisements from among the contents file stored in the storage unit 401 based on an operation input by an operator via the input device, and distributes each default content to the video signal output device 20. Further, based on an operation input from the operator, for each of the plurality of targeted contents, the information processing device 40 sets, and distributes to the video signal output device 20, a relationship between an attribute of a target to be displayed and identification information identifying a targeted content.

Further, the information processing device 40 stores a reference value for a confidence level in the storage unit 401 based on an operation input by the operator via the input device. For example, when 60% is specified as a reference value, a value indicating 60% is stored in the storage unit 401.

When receiving the default contents and the targeted contents from the information processing device 40, the video signal output device 20 stores the received contents in a storage device of the video signal output device 20, starts playing a default content, and outputs to the display device 10, a video signal corresponding to the content. The display device 10 displays in the display region, the video signal received from the video signal output device 20.

FIG. 5 is a flowchart illustrating an operation of the imaging device 30. When powered on (step S101), the imaging device 30 captures an image of a region including the shooting range SR at a predetermined frame rate (step S102), and transmits the captured image to the information processing device 40 (step S103).

The imaging device 30 determines whether or not an instruction to turn off the power has been inputted (step S104). When it is determined that an instruction to turn off the power has not been inputted (step S104—NO), the imaging device 30 proceeds to step S102. When it is determined that an instruction to turn off the power has been inputted (step S104—YES), the imaging device 30 terminates the processing.

Thus, the imaging device 30 transmits a captured image to the information processing device 40 each time the imaging device 30 captures an image at the frame rate.

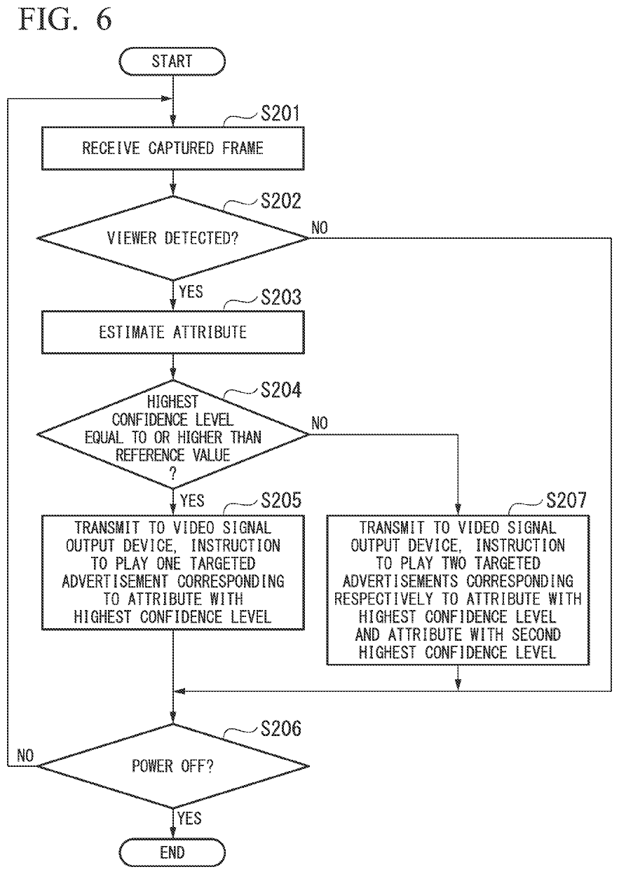

FIG. 6 is a flowchart illustrating an operation of the information processing device 40.

When the reception unit 404 receives a captured image from the imaging device 30 (step S201), the estimation unit 405 performs image recognition processing on the received captured image to determine whether a viewer has been detected from the shooting range SR (step S202).

When a viewer has not been detected (step S202—NO), the information processing device 40 proceeds to step S206.

On the other hand, when a viewer has been detected in the shooting range SR (step S202—YES), the estimation unit 405 estimates an attribute of the viewer based on the detected image of the viewer (step S203), and obtains a confidence level associated with the attribute. Here, there are cases where when a single viewer is detected, a plurality of attributes are estimated from that single viewer.

The determination unit 406 determines whether or not the highest confidence level among the confidence levels obtained by the estimation unit 405 is equal to or higher than the reference value (step S204). This determination may be made by determining whether or not the highest confidence level is equal to or higher than the reference value, or by determining whether or not the highest confidence level is less than the reference value.

When a result of the determination by the determination unit 406 indicates that the highest confidence level is equal to or higher than the reference value (step S204—YES), the extraction unit 407 extracts a single targeted content corresponding to the attribute associated with the highest confidence level. When a single content is extracted, the processing unit 409 causes the transmission unit 408 to transmit to the video signal output device 20, a playback instruction with identification information of the extracted content (step S205).

As a result, when receiving a playback instruction to play a single targeted content immediately before a playback of a currently displayed content ends, the video signal output device 20 displays the single targeted content corresponding to the playback instruction in the display region of the display device 10. The viewer can view this single content.

On the other hand, when the highest confidence level is not equal to or higher than the reference value (step S204—NO), the extraction unit 407 extracts a targeted content corresponding to the attribute associated with the highest confidence level and a targeted content corresponding to the attribute associated with the second highest confidence level. Here, a case where a quantity of contents to be extracted is previously specified as 2 will be described. When two contents are extracted, the processing unit 409 causes the transmission unit 408 to transmit to the video signal output device 20, a playback instruction with the identification information of each of the extracted contents (step S207).

As a result, when receiving a playback instruction to play two targeted contents immediately before a playback of a currently displayed content ends, the video signal output device 20 divides the display region of the display device 10 into two, arranges the two targeted contents in the respective divided regions, and simultaneously starts playing the two targeted contents. The video signal output device 20 outputs to the display device 10, video signals corresponding respectively to the two contents whose playback has been started. The display device 10 displays the two targeted contents respectively in the two divided regions divided from the single display region. This allows the viewer to view the two contents on the single display device 10.

The information processing device 40 determines whether or not an instruction to turn off the power has been inputted (step S206). When an instruction to turn off the power has not been inputted (step S206—NO), the information processing device 40 proceeds to step S201. When an instruction to turn off the power has been inputted, the information processing device 40 turns off the power.

Here, in step S202, when a plurality of viewers have been detected, the information processing device 40 may perform processing to be performed in response to the detection of the plurality of viewers, and proceed to step S206. For example, the information processing device 40 may specify one viewer from among the plurality of detected viewers and display on the display device 10, a content corresponding to an attribute of the one viewer.

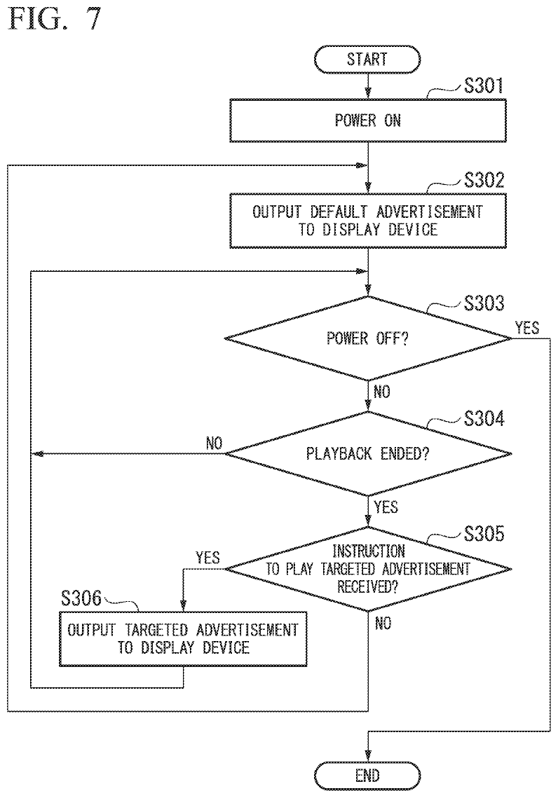

FIG. 7 is a flowchart illustrating an operation of the video signal output device 20.

When powered on (step S301), the video signal output device 20 receives default contents and targeted contents from the information processing device 40, stores the received contents in the storage device of the video signal output device 20, and starts a playback of a default content. Upon starting the playback of the default content, the video signal output device 20 outputs to the display device 10, a video signal corresponding to the default content whose playback has been started (step S302).

The video signal output device 20 determines whether or not an instruction to turn off the power has been inputted (step S303). When it is determined that an instruction to turn off the power has been inputted (step S303—YES), the video signal output device 20 terminates the processing. When it is determined that an instruction to turn off the power has not been inputted (step S303—NO), the video signal output device 20 determines whether or not the playback of the content has ended (step S304). Here, a playback time of the content is predetermined. The video signal output device 20 may determine whether or not the playback has ended by determining whether or not an elapsed time from the start of the playback has reached a playback end time indicated by the playback time. In this step S304, regardless of whether the content being played is a default content or a targeted content, the determination can be made based on whether or not the playback end time of the content being played has come.

When the video signal output device 20 is in the middle of playing the default content, and the playback end time of the playback time set to the default content has not yet come, the video signal output device 20 determines that the playback has not ended (step S304—NO), and proceeds to step S303. When determining that the playback end time of the playback time set to the default content has come (step S304—YES), the video signal output device 20 determines whether or not an instruction to play a targeted content has been received from the information processing device 40 (step S305). Here, the video signal output device 20 may determine whether or not the playback end time has come, or whether or not it is immediately before the playback end time. Whether or not it is immediately before the playback end time may be determined based on whether or not the time a predetermined time (for example, one second) before the playback end time has come.

When determining that an instruction to play a targeted content has not been received (step S305—NO), the video signal output device 20 proceeds to step S302.

When determining that an instruction to play a targeted content has been received, the video signal output device 20 transmits to the display device 10, a video signal for displaying the targeted content according to the received playback instruction and causes the display device 10 to display the targeted content (step S306). Thereafter, the video signal output device 20 proceeds to step S303.

Here, when receiving an instruction to play two targeted contents, the video signal output device 20 divides the display region into two, arranges the two targeted contents in the respective divided regions, and simultaneously plays the two targeted contents. Then, the video signal output device 20 outputs to the display device 10, video signals corresponding respectively to the two contents whose playback has been started. As a result, the two targeted contents are displayed respectively in the two divided regions divided from the single display region of the display device 10. This allows the viewer to view the two contents on the single display device 10.

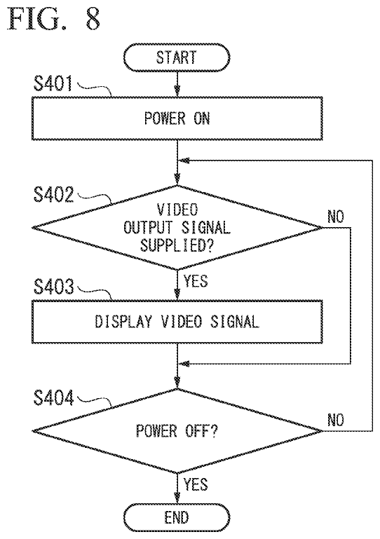

FIG. 8 is a flowchart illustrating an operation of the display device 10.

When powered on (step S401), the display device 10 determines whether or not a video signal has been supplied from the video signal output device 20 (step S402). When a video signal has been supplied (step S402—YES), the display device 10 displays in the display region, the video signal supplied from the video signal output device 20 (step S403).

The display device 10 determines whether or not an instruction to turn off the power has been inputted (step S404). When determining that an instruction to turn off the power has not been inputted (step S404—NO), the display device 10 proceeds to step S402. When determining that an instruction to turn off the power has been inputted (step S404—YES), the display device 10 terminates the processing.

When no video signal has been supplied in step S402, the display device 10 proceeds to step S404.

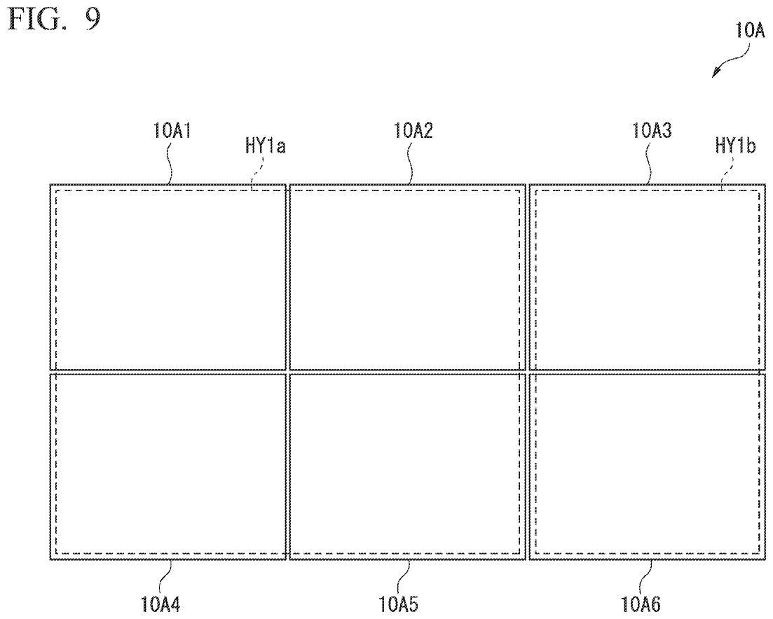

FIG. 9 is a diagram showing a case where contents are displayed on the multi-display system.

In the case where contents are displayed on the multi-display system, when receiving from the information processing device 40, a playback instruction to display a plurality of targeted contents, the video signal output device 20 divides a display region of a multi-screen of a multi-display system 10A, and displays the plurality of targeted contents respectively in the divided regions. Here, it is assumed that the multi-display system 10A includes six display devices (display device 10A1, display device 10A2, display device 10A3, display device 10A4, display device 10A5, and display device 10A6), which are arranged so that two display devices are arranged in the vertical direction, and three display devises are arranged in the horizontal direction. When receiving an instruction to play two targeted contents from the information processing device 40, the video signal output device 20 divides the display region of the multi-display system 10A into a divided region HY1a and a divided region HY1b. The divided region HY1a includes four display screens of the display device 10A1, the display device 10A2, the display device 10A4, and the display device 10A5. The divided region HY1b includes two display screens of the display device 10A3 and the display device 10A6. Then, the video signal output device 20 displays in the display region HY1a, one of the two targeted contents to be played according to the playback instruction, and displays the other targeted content in the display region HY1b.

When obtaining a plurality of divided regions from the single display region of the single display device 10 or the multi-display system, a size ratio of each divided region may be determined according to a confidence level. For example, when a targeted content with the confidence level of 50% and a targeted content with the confidence level of 40% are to be displayed, the video signal output device 20 may make a division so that the divided region for displaying the targeted content with the confidence level of 50% is larger than the divided region for displaying the targeted content with the confidence level of 40%. For example, it is possible to display the targeted content with the confidence level of 50% in the divided region HY1a, and display the targeted content with the confidence level of 40% in the divided region HY1b.

As a result, two contents based on a plurality of attributes estimated from a single viewer can be displayed together. A viewer can view both of these two contents. For example, even when an actual attribute of a single viewer is “male in his 30s,” an attribute with the highest confidence level among a plurality of attributes estimated from that single viewer is “male in his 20s.” and an attribute with the second highest confidence level is “male in his 30s,” a targeted content corresponding to “male in his 20s” and a targeted content corresponding to “male in his 30s” are displayed, so that the targeted content corresponding to the actual attribute of the viewer can also be displayed. Further, even when an actual attribute of a viewer is “male in his 30s,” he might be interested in a targeted content corresponding to the attribute of “male in his 20s.” Even in this case, since two contents can be displayed, there is an advantage that the viewer can view both of the two contents. Further, since a plurality of targeted contents are displayed at the same time, the viewer can select and view a targeted content that interests him.

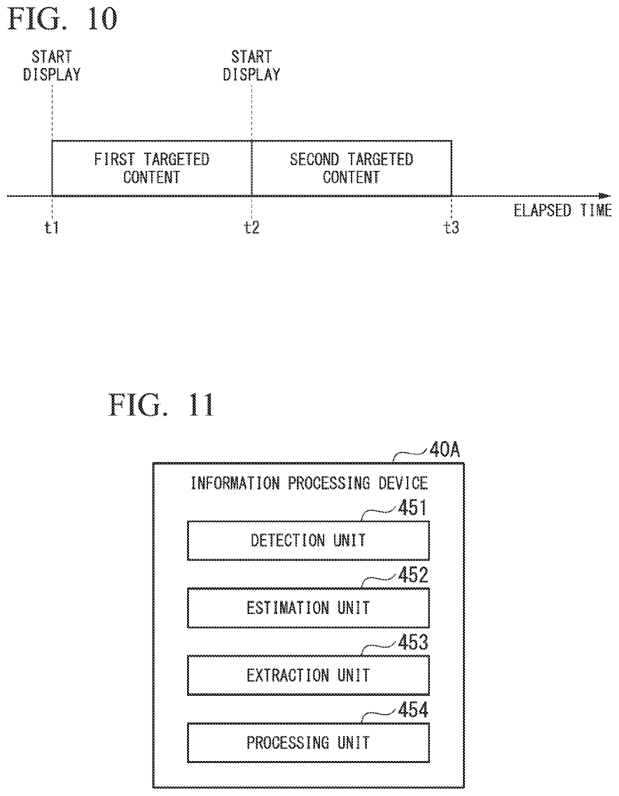

FIG. 10 is a conceptual diagram illustrating a case where a plurality of contents are played in chronological order.

When receiving from the information processing device 40, a playback instruction to play a plurality of contents in chronological order, the video signal output device 20 displays in a single display region, the plurality of targeted contents in chronological order according to the playback instruction. Here, when receiving a playback instruction to play two contents of a first targeted content (targeted content corresponding to the attribute “male in his 30s”) and a second targeted content (targeted content corresponding to the attribute “male in his 20s”), the video signal output device 20 plays the targeted contents in descending order of confidence level. For example, the video signal output device 20 causes the display device 10 to display the first targeted content at time ti. Then, when the playback end time of the first targeted content comes, the video signal output device causes the display device 10 to display the second targeted content. As a result, since the video signal output device 20 can display the two contents sequentially, the viewer can view both of the targeted contents.

Further, when the targeted contents are displayed in chronological order, the display region need not be divided, so that the targeted contents can be displayed using the entire display region.

FIG. 11 is a diagram showing a configuration of an information processing device 40A which is another embodiment of the information processing device 40. The information processing device 40A includes a detection unit 451, an estimation unit 452, an extraction unit 453, and a processing unit 454.

The detection unit 451 detects a person from a captured image capturing the person. The estimation unit 452 estimates an attribute of the detected person. When a plurality of attributes are estimated from one person, the extraction unit 453 extracts a plurality of contents to be displayed, based on a plurality of confidence levels associated respectively with the plurality of attributes obtained from the one person. The processing unit 454 causes each extracted content to be displayed in a display region.

According to the above-described embodiment, when a plurality of attributes and confidence levels are estimated from one viewer detected from an image captured by the imaging device, the information processing device can determine a plurality of contents according to the plurality of confidence levels, automatically select an effective playback pattern, and cause the plurality of contents to be displayed according to the playback pattern. As a result, it is possible to enhance the effect of having the content viewed.

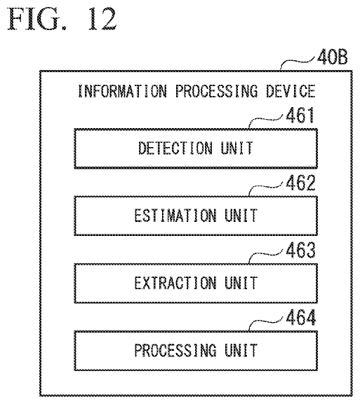

FIG. 12 is a diagram showing a configuration of an information processing device 40B which is another embodiment of the information processing device 40. The information processing device 40B includes a detection unit 461, an estimation unit 462, an extraction unit 463, and a processing unit 464.

The detection unit 461 detects a person from a captured image capturing the person. The estimation unit 462 estimates an attribute of the detected person. When a plurality of attributes are estimated from one person, the extraction unit 463 extracts one or more contents, a quantity of which is determined based on a plurality of confidence levels associated respectively with the plurality of attributes obtained from the one person. The processing unit 464 causes the one or more contents to be displayed in a display region.

According to the above-described embodiment, when a plurality of attributes and confidence levels are estimated from one viewer detected from an image captured by the imaging device, the information processing device can determine a quantity of contents to be displayed, according to the plurality of confidence levels, and cause one or more contents to be displayed according to the determined number of contents. As a result, it is possible to enhance the effect of having the content viewed.

In the above-described embodiments, the determination unit 406 compares a confidence level with a reference value, but the determination unit 406 may compare another value other than the confidence level with a reference value.

Further, according to the above-described embodiments, it is possible to provide a digital signage system capable of dynamically controlling contents to be played, including a targeted content, using a plurality of display devices.

Further, a program for realizing the functions of the processing unit in FIG. 1 may be recorded in a computer-readable recording medium, so that a computer system can read and execute the program recorded in the recording medium to perform execution managements. Here, the “computer system” referred to here includes an OS and hardware such as peripheral devices.

Further, the “computer system” includes home page providing environments (or display environments) when the WWW system is used.

Further, the “computer-readable recording medium” refers to portable media such as flexible disks, magneto-optical disks, ROMs and CD-ROMs, and storage devices such as hard disks built into computer systems. Further, the “computer-readable recording medium” includes a medium that retains a program for a certain period of time, such as a volatile memory inside a computer system that serves as a server or a client. Further, the above-described program may be one for realizing part of the above-described functions, or one capable of realizing the above-described functions in combination with a program already recorded in the computer system. Further, the above-described program may be stored in a predetermined server, so that it will be distributed (downloaded, or the like) via a communication line in response to a request from another device.

Although the embodiments of the present disclosure have been described in detail with reference to the drawings, the specific configurations are not limited to those embodiments, and include designs and the like within the scope of the gist of the present disclosure.

1. An information processing device comprising:
a detection unit configured to detect a person from a captured image capturing the person;
an estimation unit configured to estimate an attribute of the detected person;
an extraction unit configured to, when a plurality of attributes are estimated from one person, extract one or more contents to be displayed, based on a plurality of confidence levels associated respectively with the plurality of attributes; and
a processing unit configured to cause the one or more contents to be displayed in a display region.

2. The information processing device of claim 1, wherein
the extraction unit is configured to determine a quantity of contents to be displayed, based on the plurality of confidence levels.

3. The information processing device of claim 1, further comprising:
a determination unit configured to determine a magnitude relationship between a reference value and each of the plurality of confidence levels, wherein
the extraction unit is configured to extract a plurality of contents to be displayed, when a highest confidence level among the plurality of confidence levels is less than the reference value.

4. The information processing device of claim 1, wherein
the extraction unit is configured to extract a plurality of contents to be displayed, when a difference between highest confidence levels among the plurality of confidence levels is within a predetermined value.

5. The information processing device of claim 1, wherein
the processing unit is configured to, when a plurality of contents are extracted, cause each of the plurality of contents to be displayed respectively in a plurality of different display regions.

6. The information processing device of claim 1, wherein
the processing unit is configured to, when a plurality of contents are extracted, cause each of the plurality of contents to be displayed in a single display region in chronological order.

7. The information processing device of claim 1, wherein
the display region is of a display screen of a single display device,
the processing unit is configured to, when a plurality of contents are extracted, display the plurality of contents respectively in a plurality of divided regions divided from the display region.

8. The information processing device of claim 1, wherein
the display region includes a plurality of display regions arranged to constitute a multi-display system,
the processing unit is configured to, when a plurality of contents are extracted, allocate the plurality of contents respectively to a plurality of divided regions divided from a multi-display screen of the multi-display system, and cause the plurality of contents to be displayed respectively in the plurality of divided regions.

9. A content display system comprising:
a detection unit configured to detect a person from a captured image capturing the person;
an estimation unit configured to estimate an attribute of the detected person;
an extraction unit configured to, when a plurality of attributes are estimated from one person, extract one or more contents to be displayed, based on a plurality of confidence levels associated respectively with the plurality of attributes;
a processing unit configured to output a playback instruction causing the one or more contents to be displayed in a display region; and
a playback unit configured to play the one or more contents according to the playback instruction and cause the one or more contents to be displayed in the display region.

10. The content display system of claim 9, wherein
the extraction unit is configured to determine a quantity of contents to be displayed, based on the plurality of confidence levels.

11. The content display system of claim 9, further comprising:
a determination unit configured to determine a magnitude relationship between a reference value and each of the plurality of confidence levels, wherein
the extraction unit is configured to extract a plurality of contents to be displayed, when a highest confidence level among the plurality of confidence levels is less than the reference value.

12. The content display system of claim 9, wherein
the extraction unit is configured to extract a plurality of contents to be displayed, when a difference between highest confidence levels among the plurality of confidence levels is within a predetermined value.

13. A content display method comprising:
detecting a person from a captured image capturing the person;
estimating an attribute of the detected person;
when a plurality of attributes are estimated from one person, extracting one or more contents to be displayed, based on a plurality of confidence levels associated respectively with the plurality of attributes; and
causing the one or more contents to be displayed in a display region.

14. The content display method of claim 13, further comprising:
determining a quantity of contents to be displayed, based on the plurality of confidence levels.

15. The content display method of claim 13, further comprising:
determining a magnitude relationship between a reference value and each of the plurality of confidence levels; and
extracting a plurality of contents to be displayed, when a highest confidence level among the plurality of confidence levels is less than the reference value.

16. The content display method of claim 13, further comprising
extracting a plurality of contents to be displayed, when a difference between highest confidence levels among the plurality of confidence levels is within a predetermined value.

17. The content display method of claim 13, further comprising
when a plurality of contents are extracted, causing each of the plurality of contents to be displayed respectively in a plurality of different display regions.

18. The content display method of claim 13, further comprising
when a plurality of contents are extracted, causing each of the plurality of contents to be displayed in a single display region in chronological order.

19. The content display method of claim 13, wherein:
the display region is of a display screen of a single display device; and
the content display method further comprises
when a plurality of contents are extracted, displaying the plurality of contents respectively in a plurality of divided regions divided from the display region.

20. The content display method of claim 13, wherein:
the display region includes a plurality of display regions arranged to constitute a multi-display system; and
the content display method further comprises
when a plurality of contents are extracted, allocating the plurality of contents respectively to a plurality of divided regions divided from a multi-display screen of the multi-display system, and causing the plurality of contents to be displayed respectively in the plurality of divided regions.
